(19) United States
(12) Patent Application Publication
(10) Pub. No.: US 2007/0216628 A1
(43) Pub. Date: Sep. 20, 2007

(54) LCD Device with Gamma Correction Function by Adjusting Pulse Width of PWM Signal and Related Method Thereof

(76) Inventors: Shiue-Tien Ju, Hsin-Chu Hsien (TW); Hsueh-Te Lu, Taipei Hsien (TW); Jiang-Ting Chen, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/424,875

(22) Filed: Jun. 19, 2006

(30) Foreign Application Priority Data
Mar. 15, 2006 (TW) 095108828

(51) Int. Cl. G09G 3/36

(52) U.S. Cl. 345/98

(57) ABSTRACT

An LCD device includes a memory for storing image signals, a PWM clock generator for generating an aperiodic PWM clock signal according to a clock signal and a gamma correction signal, a PWM counter for generating count values corresponding to the aperiodic PWM clock signal generated by the PWM clock generator, a comparing device for comparing the image signals transmitted from the memory and the count values transmitted from the PWM counter, a PWM signal generator for generating a PWM signal with a corresponding pulse width according to a comparing result of the comparing device, an LCD panel, and a drive circuit for driving the LCD panel according to the PWM signal.

### BACKGROUND OF THE INVENTION

1. Field of the Invention

The present invention relates to a liquid crystal display (LCD) device with a gamma correction function capable of adjusting a pulse width of a pulse width modulation (PWM) signal and related method, and more particularly, to an LCD device with a gamma correction function capable of adjusting the pulse width of the pulse width modulation (PWM) signal and related method according to count values corresponding to an aperiodic PWM clock signal and a comparing result of an image signal.

2. Description of the Prior Art

The progress of science and technology has led to small, effective, and portable intelligent information products becoming a part of our lives. Display devices play an important role because all intelligent information products, such as mobile phones, personal digital assistants (PDAs), or notebooks, require display devices to function as a communication interface. The advantages of a liquid crystal display (LCD) device include portability, low power consumption, and low radiation. Therefore, the LCD device is widely used in, for example, various portable products, such as notebooks and personal data assistants (PDA). Moreover, the LCD device is gradually replacing the CRT monitor for use with desktop computers. Nevertheless, liquid crystal molecules under different arrangements have different transmittance therefore the liquid crystal molecules in different arrangements can control penetration of light to generate different intensity of outputted light, and the LCD device displays different color levels of red, blue and green by way of changing an arrangement of the liquid crystal molecules so as to display picture images.

Please refer to FIG. 1. FIG. 1 illustrates a functional block diagram of a conventional LCD device 10. The LCD device 10 includes a memory 12 for storing image signals where the memory 12 can be a static random access memory (SRAM), a frequency divider circuit 14 for receiving a clock signal to generate a periodic PWM clock signal, where the clock signal received can be a periodic output signal such as an FOSC system clock signal, a PWM counter 16 coupled to the frequency divider circuit 14 for generating count values corresponding to the PWM clock signal generated by the frequency divider circuit 14, a comparing device 18 coupled to the memory 12 and the PWM counter 16 for comparing the image signal transmitted from the memory 12 with the signal transmitted from the frequency divider circuit 14, a PWM signal generator 20 coupled to the comparing device 18 for generating a PWM signal with a corresponding pulse width according to a comparing result of the comparing device 18, and a drive circuit 24 coupled to the LCD panel 22 and the PWM signal generator 20 for driving the LCD panel 22 according to the PWM signal generated by the PWM signal generator 20.

The frequency divider circuit 14 can receive a clock signal (such as the FOSC system clock signal) and generate a periodic PWM clock signal after the frequency divided, and lastly the frequency divider circuit 14 utilizes the PWM clock signal to control the PWM counter 16. For example, please refer to FIG. 2. FIG. 2 illustrates a corresponding relationship diagram of count values generated by the PWM counter 16, the PWM clock signal, a color scale value of the image signal and the PWM signal. For a scale having eight color level, the PWM counter 16 can generate count values (e.g., count values consisting of a repeating series of 0 through 6) corresponding to the PWM clock signal generated by the frequency divider circuit 14. Next, the comparing device 18 will generate a comparing result by comparing the color scale value of the image signal read by the memory 12 with the count values generated by the PWM counter 16. Next, the comparing result is then outputted to the PWM signal generator 20. When the image signal value is greater than the count values, 1 will be outputted, if not 0 will be outputted, and the PWM signal generator 20 will generate a PWM signal with a corresponding pulse width according to the comparing result of the comparing device 18. As illustrated in FIG. 2, when the color scale value of the image signal read by the memory 12 is 5, the PWM signal generator 20 will generate a PWM signal with a corresponding 5/7 of pulse width, thus the above-mentioned method can be utilized to control the pulse width of the PWM signal. Please refer to FIG. 3. FIG. 3 illustrates a corresponding relationship diagram of the color scale value of the image signal and the pulse width of the PWM signal. A color scale having eight levels is used as an example in FIG. 3. If the color scale value of the image signal read by the memory is N, then a PWM signal with N/7 pulse width is generated.

Next, the drive circuit 24 can drive the LCD panel 22 according to the PWM signal generated by the PWM signal generator 20. Please note that, N+1 levels gray scale changes in a linear relationship between the color scale change of a pixel color and the pulse width (i.e., the gray scale volume) of a PWM signal can be represented by 0/N, 1/N, 2/N, . . . , N /N, however, there is no linear relationship between the pulse width (i.e., the gray scale voltage) of the PWM signal and the actual display characteristics (i.e., the display luminance) of the LCD panel 22. Please refer to FIG. 4. FIG. 4 illustrates a corresponding relationship diagram of the pulse width (i.e., the gray scale voltage) of a PWM signal and the actual display characteristics (i.e., the display luminance) of an LCD panel 22. From the figure, we can see that there is no linear relationship between the pulse width (i.e., the gray scale voltage) of the PWM signal and the actual display characteristics (i.e., the display luminance) of the LCD panel 22, and there will be a predetermined curve for different LCD panels 22 or under other external factors (e.g., such as temperature).

Therefore, the method of utilizing a gamma correction is practically used to achieve a linear relationship between the pulse width (i.e., the gray scale voltage) of the PWM signal and the actual display characteristics (i.e., the display luminance) of the LCD panel 22. Please refer to FIG. 5. FIG. 5 illustrates a corresponding relationship diagram of the display characteristics of the LCD panel 22 with a gamma correction function. If a relationship of an image signal value and a pulse width (i.e., a gray scale voltage) of the PWM signal is being adjusted to a non-linear relationship in curve A as illustrated in FIG. 5 through the gamma correction, the curve A is then paired up with a non-linear relationship of liquid crystal characteristics in the LCD panel 22 represented by curve B, and the color scale value of the image signal and the display color scale presented in the actual LCD panel 22 can be presented as a linear relationship in curve C to achieve the objective of the gamma correction. However, the actual method of gamma correction places a gamma correction circuit before the memory 12 to modify the image data to be stored into the memory 12 through a mapping table to achieve the objective of the gamma correction. For example, a sub-pixel of a color image data having 65K (e.g., R-G-B: 5*6*5 bits) will respectively increase by 1 bit because the purpose of the gamma correction is to perform uplifting of the curve. In other words, the color image data of R-G-B : 5*6*5 bits will be converted to color image data of R-G-B: 6*7*6 bits. For example, an R sub-pixel presented in 2⁵ color level variations can be increased to 2⁶ color level variations, thus the relationship of the image signal value and the pulse width (i.e., gray scale voltage) can be made into a corresponding non-linear relationship. However, the disadvantage of this method is that the processing required by the image data becomes greater. Taking the above scenario as an example, the data of a pixel increases from 16 bits to 19 bits, hence the processing of the image data is increased by 18.75%. In this way, demand for a larger capacity memory 12 directly increases cost, and also increases the image data calculation processes, thus this method is not an effective gamma correction mechanism.

### SUMMARY OF THE INVENTION

The claimed invention discloses a liquid crystal display (LCD) device capable of adjusting a pulse width of a pulse width modulation (PWM) signal to achieve a gamma correction function. The LCD device comprises a memory for storing an image signal; a PWM clock generator for receiving a clock signal and a gamma correction signal, and generating an aperiodic PWM clock signal according to the clock signal and the gamma correction signal; a PWM counter coupled to the PWM clock generator for generating a count value corresponding to the PWM clock signal generated by the PWM clock generator; a comparing device coupled to the memory and the PWM counter for comparing the image signal transmitted from the memory with the count value transmitted from the PWM counter; a PWM signal generator coupled to the comparing device for generating a PWM signal with a corresponding pulse width according to a comparing result of the comparing device; an LCD panel; and a drive circuit coupled to the LCD panel and the PWM signal generator for driving the LCD panel according to the PWM signal.

The claimed invention further discloses an LCD driver capable of adjusting a pulse width of a PWM signal to achieve a gamma correction function of an LCD panel. The LCD driver comprises a memory for storing an image signal; a PWM clock generator for receiving a clock signal and a gamma correction signal, and generating an aperiodic PWM clock signal according to the clock signal and the gamma correction signal; a PWM counter coupled to the PWM clock generator for generating a count value corresponding to the PWM clock signal generated by the PWM clock generator; a comparing device coupled to the memory and the PWM counter for comparing the image signal transmitted from the memory and the count value transmitted from the PWM counter; a PWM signal generator coupled to the comparing device for generating a PWM signal with a corresponding pulse width according to a comparing result of the comparing device; and a drive circuit coupled to the PWM signal generator for driving the LCD panel according to the PWM signal generated by the PWM signal generator.

The claimed invention further discloses a drive chip of an LCD device. The drive chip comprises a memory for storing an image signal; a PWM clock generator for generating an aperiodic PWM clock signal; a counter coupled to the PWM clock generator for generating a count value corresponding to the PWM clock signal generated by the PWM clock generator; a comparing device coupled to the memory and the counter for comparing the image signal transmitted from the memory with the count value transmitted from the counter; a PWM signal generator coupled to the comparing device for generating a PWM signal with a corresponding pulse width according to a comparing result of the comparing device; and a drive circuit coupled to the PWM signal generator for driving the LCD device according to the PWM signal generated by the PWM signal generator.

The claimed invention further discloses a method of adjusting pulse width of a PWM signal to gamma-correct an LCD panel. The method comprises receiving a clock signal and a gamma correction signal; generating an aperiodic PWM clock signal according to the clock signal and the gamma correction signal; generating a count value corresponding to the PWM clock signal generated in the previous step; comparing an image signal with the count value generated in the previous step; generating a PWM signal with a corresponding pulse width according to the comparing result of the previous step; and driving the LCD panel according to the PWM signal generated in the previous step.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a functional block diagram of a conventional LCD device.

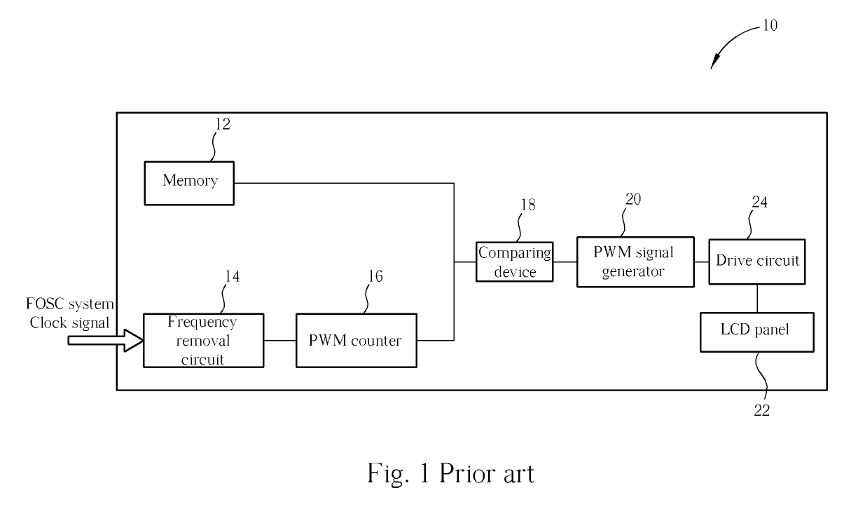

FIG. 2 illustrates a conventional corresponding relationship diagram of count values generated by a PWM counter, a PWM clock signal, color scale value of an image signal and a PWM signal.

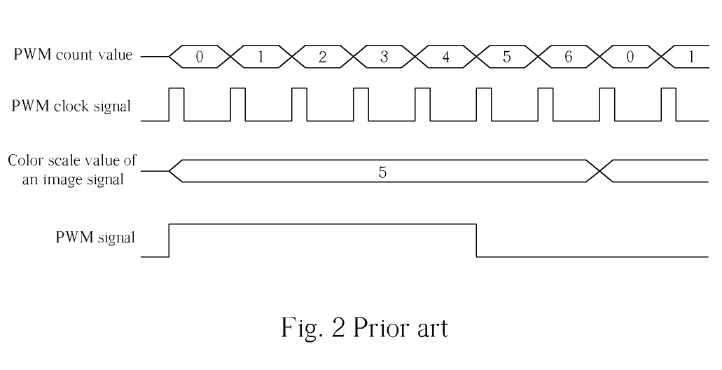

FIG. 3 illustrates a conventional corresponding relationship diagram of color scale value of image signal and pulse width of PWM signal.

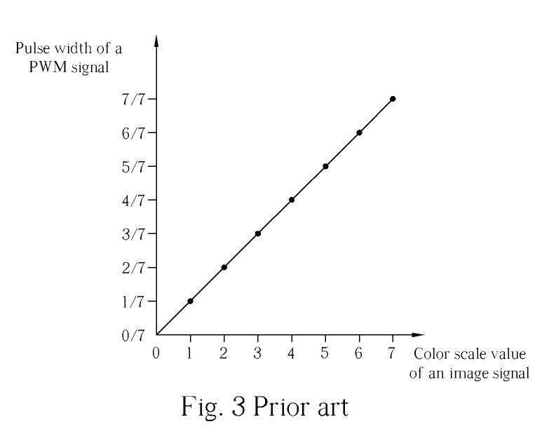

FIG. 4 illustrates a conventional corresponding relationship diagram of pulse width of a PWM signal and actual display characteristics of an LCD panel.

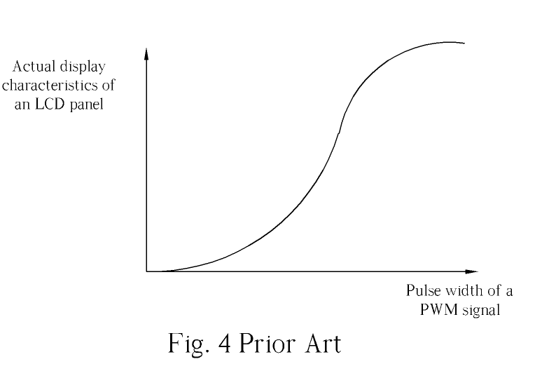

FIG. 5 illustrates a conventional corresponding relationship diagram of display characteristics of an LCD panel with a gamma correction function.

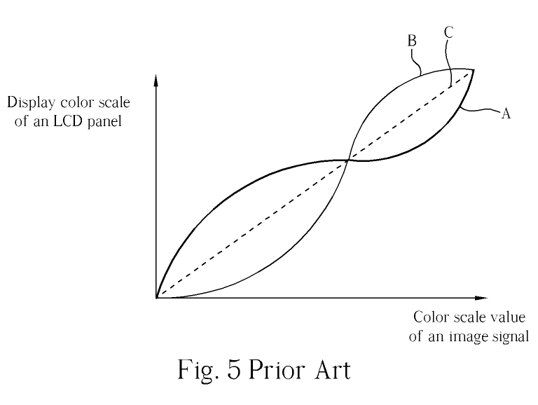

FIG. 6 illustrates a functional block diagram of an LCD device according to an embodiment of the present invention.

FIG. 7 illustrates a flowchart of controlling pulse width of a PWM signal in order to achieve gamma correction in an LCD panel according to the present invention.

FIG. 8 illustrates a diagram of a gamma correction table.

FIG. 9 illustrates a corresponding relationship diagram of count values generated by the PWM counter, the PWM clock signal, the image signal, and the PWM signal according to the present invention.

FIG. 10 illustrates a corresponding relationship diagram of color scale values of an image signal and pulse width of a PWM signal.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

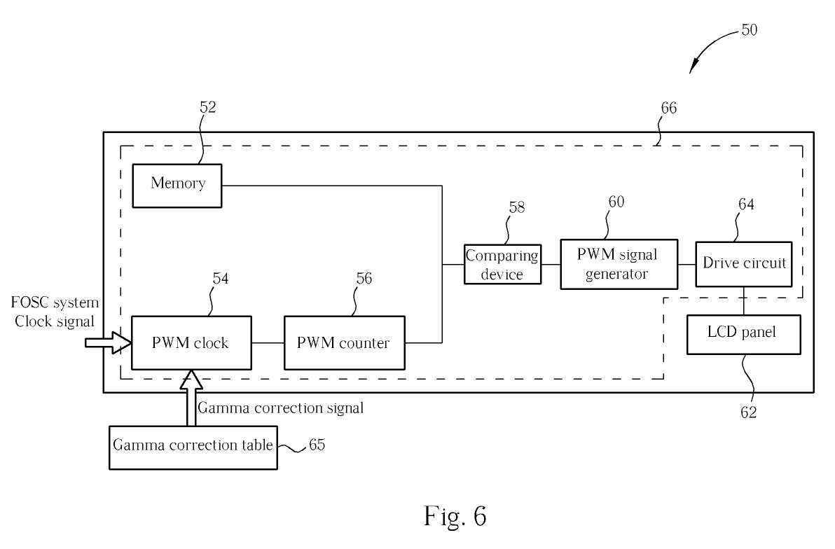

Please refer to FIG. 6. FIG. 6 illustrates a functional block diagram of a liquid crystal display (LCD) device 50. The LCD device 50 includes a memory 52 for storing image signals, the image signals can be a static random access memory (SRAM), a PWM clock 54 for receiving a clock signal and a gamma correction signal, and for generating an aperiodic PWM clock signal according to the clock signal and the gamma correction signal, where the received clock signal can be a periodic output signal and the received gamma correction signal is generated according to a gamma correction table, a PWM counter 56 coupled to the PWM clock generator 54 for generating count values corresponding to the PWM clock signal generated by the PWM clock generator, a comparing device coupled to the memory 52 and the PWM counter 56 for comparing the image signal transmitted from the memory 52 with the signal transmitted from the PWM counter 56, a PWM signal generator 60 coupled to the comparing device 58 for generating a PWM signal with a corresponding pulse width according to a comparing result of the comparing device, an LCD panel 62, and a drive circuit 64 coupled to the LCD panel 62 and the PWM signal generator 60 for driving the LCD panel 62 according to the PWM signal. Moreover, the memory 52, the PWM clock generator 54, the PWM counter 56, the comparing device 58, the PWM signal generator 60, and the driver circuit 64 can be combined into a liquid crystal driver 66, such as an LCD drive chip.

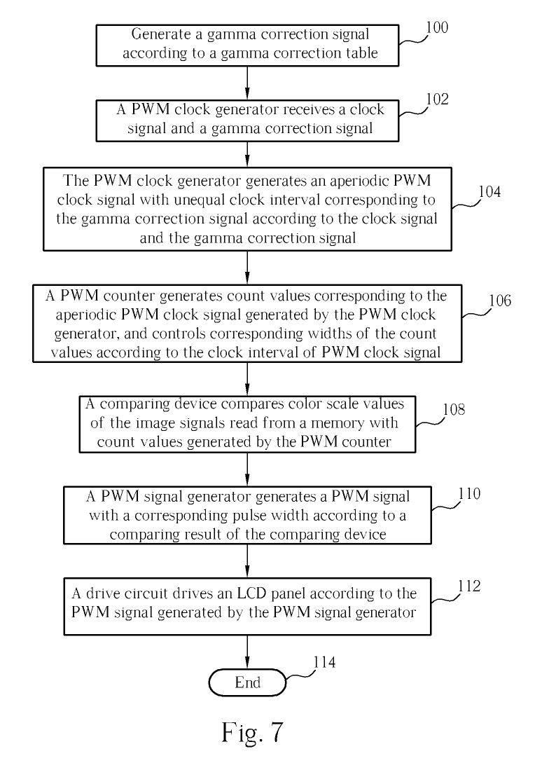

Please refer to FIG. 7. FIG. 7 illustrates a flowchart of controlling the pulse width of a PWM signal in order to achieve gamma correction in an LCD panel 62 according to the present invention. The method of the present invention includes the following steps:

Step 100: generate a gamma correction signal according to a gamma correction table 65;

Step 102: a PWM clock generator 54 receives a clock signal and a gamma correction signal;

Step 104: the PWM clock generator 54 generates an aperiodic PWM clock signal with unequal clock interval corresponding to the gamma correction signal according to the clock signal and the gamma correction signal;

Step 106: a PWM counter 56 generates count values corresponding to the PWM clock signal generated by the PWM clock generator 54, and controls corresponding widths of the count values according to the clock interval of the PWM clock signal;

Step 108: a comparing device 58 compares color scale values of the image signals read from memory 52 with count values generated by the PWM counter 56;

Step 110: a PWM signal generator 60 generates a PWM signal with a corresponding pulse width according to a comparing result of the comparing device 58;

Step 112: a drive circuit 64 drives an LCD panel 62 according to the PWM signal generated by the PWM signal generator 60;

Step 114: end.

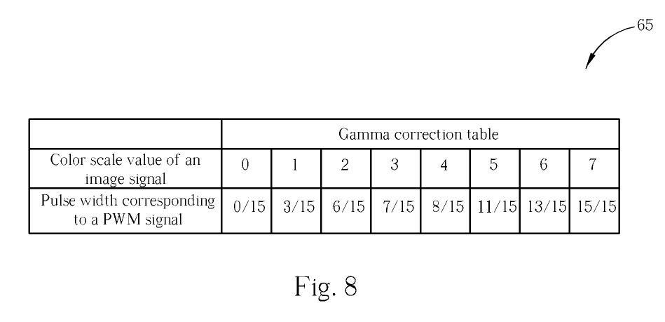

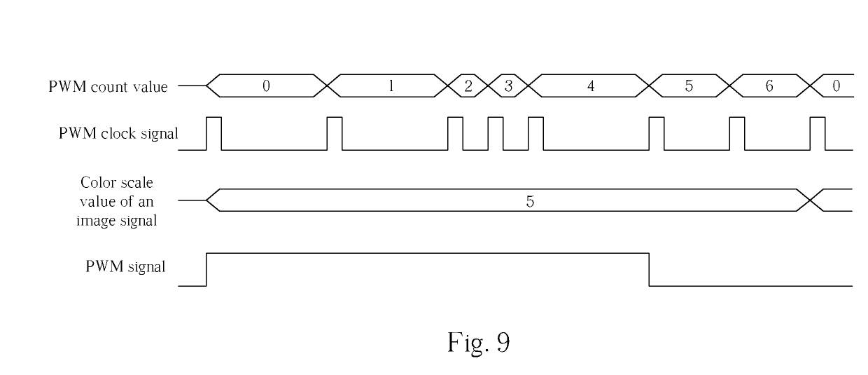

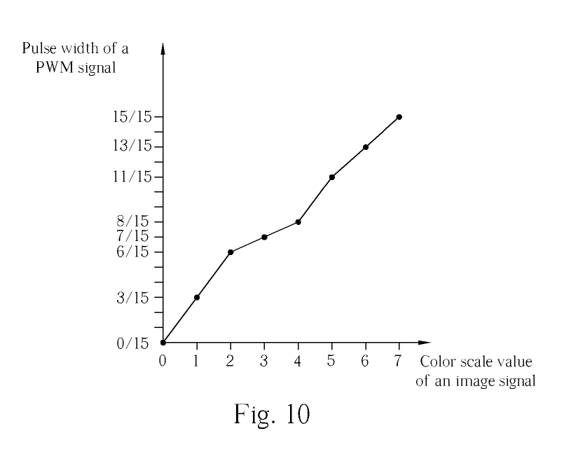

To further explain the above steps in detail, the PWM clock generator 54 can receive the clock signal (e.g., such as a clock signal of the FOSC system) and the gamma correction signal generated by the gamma correction table 65, and the PWM clock generator 54 can generate the aperiodic PWM clock signal with unequal clock interval corresponding to the gamma correction signal according to the clock signal and the gamma correction signal. Therefore, the PWM clock signal can be used to control the PWM counter 56. For example, please refer to FIG. 8 and FIG. 9. FIG. 8 illustrates a diagram of a gamma correction table 65. FIG. 9 illustrates a corresponding relationship diagram of count values generated by the PWM counter 56, the aperiodic PWM clock signal, the image signal, and the PWM signal. As illustrated in FIG. 8, an eight level color scale is used as an example, a corresponding relationship between the color scale value N(0≦N≦7) of the image signal stored in the memory 52 and a unit pulse width of the corresponding PWM signal generated during the gamma correction is a non-linear relationship. As illustrated in FIG. 9, the PWM clock generator 54 can generate the aperiodic PWM clock signal with unequal clock interval corresponding to the gamma correction table 65 as illustrated in FIG. 8 according to the gamma correction signal generated by the gamma correction table 65. Next, the PWM counter 56 can generate count values (e.g., count values comprising the repeated series from 0 through 6) corresponding to the PWM clock signal generated by the PWM clock generator 54, and the width of the count value corresponds to the clock interval of the PWM clock signal. Next, the comparing device 58 will compare the color scale value of the image signal read from the memory 52 with the count values generated by the PWM counter 56, and a comparing result is then outputted to the PWM signal generator 60. When the color scale value of the image signal is greater than the count values, 1 is outputted, otherwise, 0 will be outputted. The PWM signal generator 60 will then generate a PWM signal with a corresponding pulse width according to the comparing result of the comparing device 58, where the pulse width of the PWM signal corresponds to the width corresponding to the count value. As illustrated in FIG. 9, when the color scale value of the image signal read from the memory 52 is 5, the PWM signal generator 60 will generate a PWM signal with a corresponding pulse width of 11/15. Therefore, the above-mentioned method can be utilized to control the pulse width of the PWM signal. Please refer to FIG. 10. FIG. 10 illustrates a corresponding relationship diagram of the color scale values of an image signal and the pulse width of a PWM signal. Take a color scale having eight levels as an example, if color scale value of the image signal read from the memory 52 is N(0≦N≦7), an aperiodic PWM clock signal with unequal clock interval generated by the gamma correction signal according to the gamma correction table 65 can correct the color scale value of an original image signal to a preset M scale (i.e., the correction relationship can be retrieved by referring to the gamma correction table). If the color scale count after gamma correction is x multiple of the original color scale count, then a PWM signal with M/(8X−1) unit pulse width can be generated. The gamma correction method of other different color scale count is similar to the above-mentioned theory to generate a corresponding aperiodic PWM clock signal with unequal clock interval according to the gamma correction signal generated by the corresponding gamma correction table, and a PWM signal with corresponding pulse width is generated to achieve the objective of gamma correction, hence the details of this operation will not be reiterated for the sake of brevity.

Next, the drive circuit 64 can drive the LCD panel 62 according to the PWM signal generated by the PWM signal generator 60. As illustrated in FIG. 10, the corresponding relationship of the color scale value of the image signal and the pulse width of the PWM signal is a non-linear relationship, in other words, the non-linear relationship of FIG. 10 adjusted by the gamma correction is paired up with the non-linear relationship displayed by the liquid crystal characteristics of the LCD panel 62, therefore the color scale value of the image signal and display color scale presented on the LCD panel 62 display a linear relationship, hence the objective of gamma correction is achieved.

In comparison to the prior art, the present invention controls the pulse width of the PWM signal to achieve the gamma correction function according to the comparing result of the count values corresponding to the aperiodic PWM clock signal and the image signal. In other words, the frequency of the aperiodic PWM clock signal can be simply adjusted to change the pulse width of the PWM signal to the pulse width of the gamma correction, and the function of the gamma correction can be achieved without having to increase the memory capacity and processing requirements of the image data.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display (LCD) device capable of adjusting a pulse width of a pulse width modulation (PWM) signal to achieve a gamma correction function, the LCD device comprising:
a memory for storing an image signal;
a PWM clock generator for receiving a clock signal and a gamma correction signal, and generating an aperiodic PWM clock signal according to the clock signal and the gamma correction signal;
a PWM counter coupled to the PWM clock generator for generating a count value corresponding to the PWM clock signal generated by the PWM clock generator;
a comparing device coupled to the memory and the PWM counter for comparing the image signal transmitted from the memory with the count value transmitted from the PWM counter;
a PWM signal generator coupled to the comparing device for generating a PWM signal with a corresponding pulse width according to a comparing result of the comparing device;
an LCD panel; and
a drive circuit coupled to the LCD panel and the PWM signal generator for driving the LCD panel according to the PWM signal.

2. The LCD device of claim 1 wherein the memory is a static random access memory (SRAM).

3. The LCD device of claim 1 wherein the clock signal received by the PWM clock generator is a periodic output signal.

4. The LCD device of claim 1 wherein the gamma correction signal received by the PWM clock generator is generated according to a gamma correction table.

5. A liquid crystal display (LCD) driver capable of adjusting a pulse width of a pulse width modulation (PWM) signal to achieve a gamma correction function of an LCD panel, the LCD driver comprising:
a memory for storing an image signal;
a PWM clock generator for receiving a clock signal and a gamma correction signal, and generating an aperiodic PWM clock signal according to the clock signal and the gamma correction signal;
a PWM counter coupled to the PWM clock generator for generating a count value corresponding to the PWM clock signal generated by the PWM clock generator;
a comparing device coupled to the memory and the PWM counter for comparing the image signal transmitted from the memory and the count value transmitted from the PWM counter;
a PWM signal generator coupled to the comparing device for generating a PWM signal with a corresponding pulse width according to a comparing result of the comparing device; and
a drive circuit coupled to the PWM signal generator for driving the LCD panel according to the PWM signal generated by the PWM signal generator.

6. The LCD driver of claim 5 wherein the memory is a static random access memory (SRAM).

7. The LCD driver of claim 5 wherein the clock signal received by the PWM clock generator is a periodic output signal.

8. The LCD driver of claim 5 wherein the gamma correction signal received by the PWM clock generator is generated according to a gamma correction table.

9. A drive chip of a liquid crystal display (LCD) device, the drive chip comprising:
a memory for storing an image signal;
a pulse width modulation (PWM) clock generator for generating an aperiodic PWM clock signal;
a counter coupled to the PWM clock generator for generating a count value corresponding to the PWM clock signal generated by the PWM clock generator;
a comparing device coupled to the memory and the counter for comparing the image signal transmitted from the memory with the count value transmitted from the counter;
a PWM signal generator coupled to the comparing device for generating a PWM signal with a corresponding pulse width according to a comparing result of the comparing device; and
a drive circuit coupled to the PWM signal generator for driving the LCD device according to the PWM signal generated by the PWM signal generator.

10. The drive chip of claim 9 wherein the PWM clock generator is utilized for receiving a clock signal and a gamma correction signal, and generating the aperiodic PWM clock signal according to the clock signal and the gamma correction signal.

11. The drive chip of claim 10 wherein the clock signal received by the PWM clock generator is a periodic output signal.

12. The drive chip of claim 10 wherein the gamma correction signal received by the PWM clock generator is generated according to a gamma correction table.

13. The drive chip of claim 9 wherein the memory is a static random access memory (SRAM).

14. A method of adjusting a pulse width of a PWM signal to gamma-correct a liquid crystal display (LCD) panel, the method comprising:
(a) receiving a clock signal and a gamma correction signal;
(b) generating an aperiodic PWM clock signal according to the clock signal and the gamma correction signal;
(c) generating a count value corresponding to the PWM clock signal generated in step (b);
(d) comparing an image signal with the count value generated in step (c);
(e) generating a PWM signal with a corresponding pulse width according to the comparing result of step (d); and
(f) driving the LCD panel according to the PWM signal generated in step (e).

15. The method of claim 14 further comprising generating the gamma correction signal according to a gamma correction table.

16. The method of claim 14 wherein step (b) comprises generating the PWM clock signal with unequal clock interval corresponding to the gamma correction signal according to the clock signal and the gamma correction signal.

17. The method of claim 16 wherein step (c) comprises adjusting corresponding width of the count value according to the clock interval of the PWM clock signal generated in step (b).

18. The method of claim 17 wherein step (e) comprises generating the PWM signal with a corresponding pulse width according to the comparing result of step (d) and the corresponding width of the count value.

19. The method of claim 14 wherein step (d) comprises comparing a color scale value of the image signal and the count value generated in step (c).

20. The method of claim 14 further comprising reading the image signal from a memory.
